(19) United States
(12) Patent Application Publication
(10) Pub. No.: US 2015/0324402 A1
(43) Pub. Date: Nov. 12, 2015

(54) COMPARISON BETWEEN TREATMENT PLANS

(71) Applicant: International Business Machines Corporation, Armonk, NY (US)

(72) Inventors: BOAZ CARMELI, Koranit (IL); ESTHER GOLDBRAICH, Haifa (IL); ARIEL FARKASH, Shimshit (IL); YEVGENIA TSIMERMAN, Haifa (IL); ZEEV WAKS, Petach Tikva (IL)

(73) Assignee: International Business Machines Corporation, Armonk, NY (US)

(21) Appl. No.: 14/274,777

(22) Filed: May 12, 2014

(51) Int. Cl. G06F 17/30; G06N 99/00; G06F 19/00

(52) U.S. Cl. CPC G06F 17/30327; G06F 19/324; G06N 99/005

(57) ABSTRACT

A method comprising using at least one hardware processor for: computing a tree edit distance between two medical treatment plans; and displaying an output based on the computed tree edit distance. The two medical treatment plans are optionally a recommended treatment plan and an executed treatment plan. The output is optionally indicative of compliance of the executed treatment plan with the recommended treatment plan.

### BACKGROUND

The present invention relates to the field of computerized clinical systems.

Clinical practice guidelines are implemented in many, if not most, health institutions. These guidelines often include systematic statements developed to assist health practitioners in providing care to a patient under specific medical circumstances. Such guidelines are believed to improve the quality of care provided to the patient, while wisely utilizing the resources of the health institution.

Despite wide promulgation, clinical practice guidelines are many times not complied with by practitioners. Much research has been devoted for finding possible reasons to this lack of compliance, in order to suggest solutions. For example, a meta-analysis by Canaba et al. (1999) pointed out numerous possible reasons for the lack of adherence to guidelines, some major ones being lack of awareness of guidelines by practitioners, disagreement with the guidelines by practitioners, and low self-efficacy of practitioners. See Cabana M D, Rand C S, Powe N R, et al. “Why Don't Physicians Follow Clinical Practice Guidelines?: A Framework for Improvement.” JAMA. 1999; 282(15):1458-1465.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a method comprising using at least one hardware processor for: computing a tree edit distance between two medical treatment plans; and displaying an output based on the computed tree edit distance.

Another embodiment provides a computer program product for medical treatment plan assessment, the computer program product comprising a non-transitory computer-readable storage medium having program code embodied therewith, the program code executable by at least one hardware processor for: computing a tree edit distance between two medical treatment plans; and displaying an output based on the computed tree edit distance.

In some embodiments, the two medical treatment plans are a recommended treatment plan and an executed treatment plan; and the output is indicative of compliance of the executed treatment plan with the recommended treatment plan.

In some embodiments, the method further comprises using said at least one hardware processor for repeating said computing for multiple recommended treatment plans, wherein, in each repetition, a tree edit distance between the executed treatment plan and a different one of the multiple recommended treatment plans is computed, and wherein the output indicates which of the multiple recommended treatment plans is closest to the executed treatment plan.

In some embodiments, each of the two treatment plans is modeled as a tree structure having a hierarchy of nodes, wherein each of the nodes is labeled with a medical treatment descriptor.

In some embodiments, each of said nodes is assigned with an edit cost indicative of a clinical significance of the edit, and said computing of the tree edit distance is based on the edit cost.

In some embodiments, the edit cost is defined by a human medical expert.

In some embodiments, the edit cost is defined by a machine learning algorithm.

In some embodiments, an input to the machine learning algorithm is historical treatment success data.

In some embodiments, an input to the machine learning algorithm is a difference between the two medical treatment plans, as indicated by a human medical expert.

In some embodiments, the edit cost is higher for nodes higher in the hierarchy and is lower for nodes lower in the hierarchy.

In some embodiments, the edit cost is different for different types of edit operations.

In some embodiments, the program code is further executable by said at least one hardware processor for repeating said computing for multiple recommended treatment plans, wherein, in each repetition, a tree edit distance between the executed treatment plan and a different one of the multiple recommended treatment plans is computed, and wherein the output indicates which of the multiple recommended treatment plans is closest to the executed treatment plan.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows an illustrative tree structure of an exemplary treatment plan, modeled in accordance with present embodiments; and

FIG. 2 shows a flow chart of a method for assessing a treatment plan, in accordance with some embodiments.

### DETAILED DESCRIPTION

Disclosed herein is a method for determining a difference between two medical treatment plans, such as a recommended medical treatment plan and an executed medical treatment plan. The method may be utilized, for example, for determining whether a certain medical treatment, which was executed or is planned to be executed for a particular patient, adheres to medical guidelines pertaining to the same medical circumstances; a numerical score as to the level of deviation, if one exists, may be provided. At a larger scale, the method may be used for enhancing statistical analysis of adherence to medical treatment plans. For instance, it may be possible to identify a correlation (or the lack thereof) between the determined adherence of different medical treatment plans to the medical guidelines, and the clinical results (success, failure) of these plans. Such analysis may lead, for example, to the amendment of the medical guidelines in favor of better medicine.

Advantageously, the difference between the two medical treatment plans is determined by computing a tree edit distance between them. Edit distance, as known in the field of computer science, is a technique for quantifying how dissimilar two strings are to one another by counting the minimum number of operations required to transform one string into the other. The technique is based on a set of allowed operations, commonly including insertion, deletion and substitution, but optionally extending to further operations. Tree edit distance is a variant of the edit distance technique; this variant quantifies the dissimilarity between data organized as two tree structures, while taking into account the multi-level structure (i.e. hierarchy) of the tree.

To adapt the two medical treatment plans to the tree edit technique, each of these treatment plans may be modeled as a tree structure. The tree structure may have a hierarchy of nodes, with certain interconnection between nodes, representing their form of nesting. Each node may be labeled with a medical treatment descriptor, which includes one or more parameters such as medical treatment type, medical treatment name, medication dosage, timing, and more.

The hierarchy, advantageously, may indicate a clinical significance of different nodes; generally, nodes of a higher level (i.e. positioned higher in the hierarchy) have a higher clinical significance than nodes of a lower level. This endows concrete, quantifiable meaning to the tree structure; the clinical significance of each node and/or level is thereby taken into account when computing the tree edit distance. Hence, the final, computed tree edit distance is indeed representative of clinically-significant differences between the two medical treatment plans.

The term “medical treatment plan” (or simply “treatment plan”), as referred to herein, may relate to a group of discrete medical treatments (hereinafter “treatments” or “procedures”) which are carried out sequentially, concurrently and/or with a partial overlap in timing. Such a treatment plan may be aimed at completely curing a certain medical condition, or be considered as one stage of attempting the curing or at least ameliorating the condition. Merely as an example, a treatment plan may be aimed at attempting to cure a certain type of cancer, by employing multiple treatments such as surgical tumor excision, chemotherapy, drug administration, radiotherapy, etc. The treatments in a given treatment plan may be different from one another. Alternatively, a given treatment plan may repeat the same treatment twice or even more. In some embodiments, the term “treatment” is intended to also cover a diagnostic process; namely, a treatment may be a certain diagnostic test.

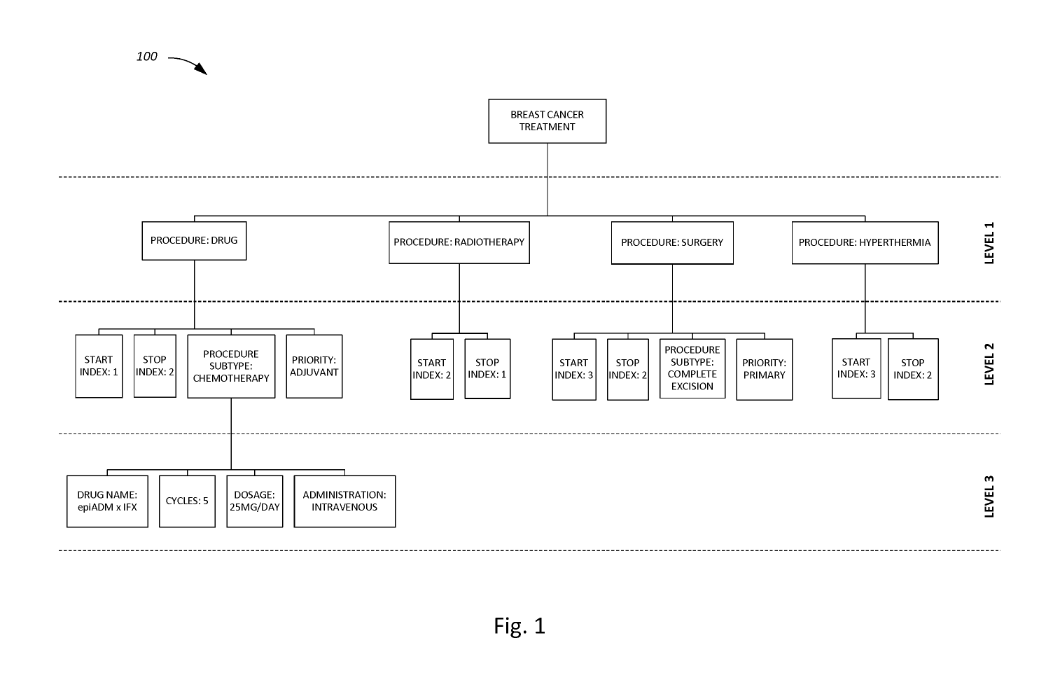

Reference is now made to FIG. 1, which shows an illustrative tree structure 100 of an exemplary treatment plan, modeled in accordance with present embodiments. The treatment plan shown in this figure may be either the recommended one or the executed one, since they are both modeled according to the same principles. This exemplary treatment plan concerns cancer treatment.

Tree structure 100 may include a rooted hierarchy of multiple levels. In this example, tree structure 100 includes three levels. Each level may include one or more nodes, shown in the figure as rectangles, wherein a discrete treatment may be represented by one or a number of nodes. The representation of a discrete treatment by multiple nodes may be useful in that it allows assigning a different edit cost to each node, thereby enhancing the resolution of tree structure 100. In tree structure 100, each node is labeled with a medical treatment descriptor (hereinafter “descriptor”), shown as text within the rectangle. The descriptor may be constructed of a parameter and its value. For example, in level 1 of tree structure 100, the parameter “procedure” has four different values in four different nodes: “drug”, “radiotherapy”, “surgery” and “hyperthermia”.

Elements of tree structure 100 will now be described in greater detail. Level 1 may include one or multiple nodes nested from a root (“breast cancer treatment”) of the tree; in this example, this level includes four nodes of medical procedures: “procedure: drug”, “procedure: radiotherapy”, “procedure: surgery” and “procedure: hyperthermia”. Nodes in level 1, which is the topmost level, are representative of those treatments having the highest clinical significance in tree structure 100. Namely, when tree 100 is later compared to a tree structure of a different treatment plan, any change (e.g. insertion, deletion, substitution, etc.) made in level 1 will have a relatively large impact on the computed distance.

Level 2 may include one or multiple nodes nested below and interconnected to respective nodes of level 1. In this example, the “procedure: drug” node of level 1 has four nested nodes in level 2: “start index: 1”, “stop index: 2”, “procedure subtype: chemotherapy” and “priority: adjuvant”. Namely, the procedure subtype of “chemotherapy” is represented by four nodes in level 2, all nested from the “procedure: drug” node of level 1.

The values of the “start index” and “stop index” parameters may be used to denote the timing of the chemotherapy in the course of the treatment plan; namely, when chemotherapy starts and stops. A different timing denomination technique, as known in the art, may be used.

The value of the “priority” parameter may denote the criticality of that treatment. Example values are “primary”, “adjuvant”, “neoadjuvant”, “pre operator”, “post operator”, “complementary”, etc. The “priority” parameter may act to augment or replace the clinical significance attributed to a certain treatment. Namely, if this parameter indicates that this treatment is complementary, then an edit cost associated with various nodes of this treatment may be reduced.

Level 2, in this example, includes further nodes nested from the “procedure: radiotherapy”, “procedure: surgery” and “procedure: hyperthermia” nodes of level 1. The same explanation given above regarding various descriptors is also applicable to descriptors of these further nodes of level 2.

Level 3, in this example, includes four nodes nested from the “procedure subtype: chemotherapy” node of level 2. Descriptors of these four nodes relate to the name of the drug used in the chemotherapy, the number of treatment cycles with the drug, its dosage and route of administration to the patient.

It is emphasized, again, that tree structure 100 is one illustrative example of a tree structure. According the same principles discussed here, a tree structure in reality may have a different number of nodes distributed over a different number of levels, etc.

Each node of tree structure 100 may be assigned an edit cost, which will affect the results of computing the tree edit distance between the two treatment plans. The edit cost may be numerical, given on any desired scale. The edit cost may be divided, for each node, to different sub-costs associated with each type of edit operation (e.g. insertion, deletion, substitution, etc.). Alternatively, the edit cost may be one for each node, regardless of the type of the edit operation. Since a single treatment is optionally represented by multiple nodes (for example, see the nodes nested from the “procedure: drug” node of level 1), each of these nodes may have the same or a different edit cost. Alternatively, the edit cost may be dependent on both the original node (before the edit operation, namely of a first treatment plan) and the resulting node (after the edit operation, namely of a second treatment plan).

There are a number of options of how to assign this edit cost. One option is to assign it fully automatically. In one variant of this option, nodes of a certain level are automatically assigned an edit cost which has been categorically predetermined for that level. The edit cost may gradually decrease as a level's distance from the root increases. Namely, levels higher in the hierarchy (i.e. closer to the root) will have a higher edit cost, and vice versa. In another variant of this option, nodes having the same parameter in their descriptors may be automatically assigned a same edit cost. To this end, a predetermined table may be provided, denoting the edit cost for each parameter. In a more complex variant, a detailed rule set, provided by one or more medical experts, may be used for assigning edit costs for nodes. The rule set may dictate, for example, edit costs for altering a treatment type (e.g. replacing chemotherapy with radiotherapy), for altering drug dosages, etc. The rule set may be very detailed, and drill-down into many treatments of various medical conditions, providing a rule for each.

Another option is to assign the edit cost for each node manually, by the user (e.g. a human medical expert). A further option combines automatic and manual assignment—an initial edit cost for all or some nodes may be defined automatically, followed by an adjustment by the user.

Yet another option is to assign the edit cost using a machine learning algorithm. A first variant of this option is to present one or more human medical experts with a training set of data, including multiple pairs of treatment plans. The experts may be requested to opine, as to each pair, the degree of clinically-significant differences between members of the pair. Based on this input from the experts, the machine learning algorithm may learn to associate certain differences between treatment plans with certain tree edit costs. Given such tree edit costs, the algorithm may recommend the edit costs (per node, level, etc.) needed to achieve the goal of the tree edit cost.

A second variant of the machine learning option is to assign the edit cost based on historical treatment success data. A training set may include multiple pairs of treatment plans and information relating to a degree of success of these plans. Based on the success information, the machine learning algorithm may lean to associate certain differences between treatment plans with certain tree edit costs. The likely outcome of this machine learning process is an increase to the edit costs of plans that were a relative failure, and a decrease of the edit costs of plans that were a relative success. This means that, for future executed treatment plans, the computed tree edit distance will also reflect the probability of success of these treatments, and not just their literal deviation from a recommended treatment plan.

In some embodiments, the modeling of a treatment plan as a tree structure may be performed by a user, using a user interface (optionally graphical, i.e. GUI) configured to construct the tree structure from different building blocks. For example, the user interface may provide a library of treatments, from which the user may select relevant treatments, for example by dragging them from the library and dropping them onto a virtual work canvas. The user interface may enable the user to define one or multiple nodes per treatment, place these nodes in a suitable level, nest one or more additional nodes in a lower level, and so on and so forth. Those of skill in the art will recognize that it is possible to construct such user interface in many different ways, while allowing the aforesaid functionality.

In some embodiments, the modeling of a treatment plan as a tree structure may be partially automatic. The user may provide a textual treatment plan structured with certain syntax, and a computerized algorithm may interpret the syntax and convert the textual treatment plan into a tree structure. This may be performed, for example, according to the “syntax tree” concept known in the field of computer science.

It should be emphasized that the tree structure need not be expressed graphically. Its graphical representation in FIG. 1 is meant to be illustrative. In practice, the tree structure is a combinatorial structure that can be manifested differently using different known data structures in various programming languages or the like.

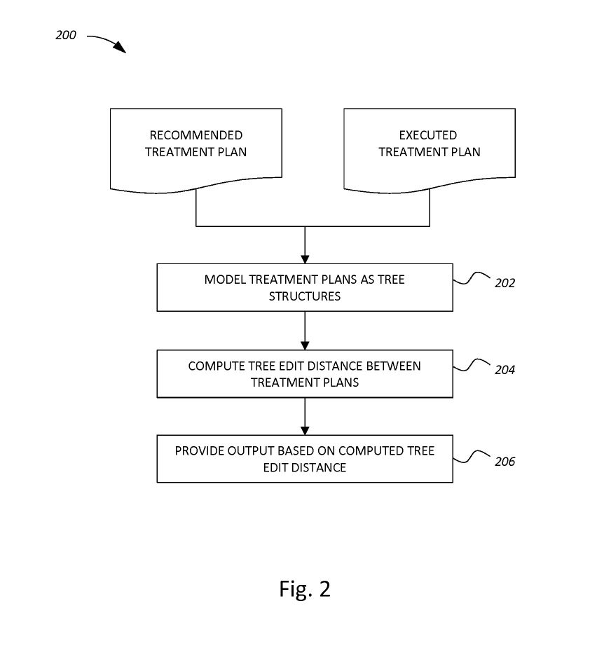

Reference is now made to FIG. 2, which shows a flow chart of a method 100 for assessing a treatment plan (e.g. an executed treatment plan), by computing a tree edit distance between two treatment plans, in accordance with some embodiments.

In an optional step 202, the two treatment plans may be each modeled as a tree structure, according to the discussions above with regard to FIG. 1. Alternatively, one or both treatment plans may be already provided to method 200 as tree structures, and their modeling is performed in a separate process, either manually, automatically, semi-automatically, etc.

In a step 204, a tree edit distance between the two treatment plans (T₁, T₂) is computed. A general-purpose tree edit distance algorithm may be utilized for this step; multiple such algorithms are known in the art. The tree edit distance algorithm utilizes the edit cost(s) associated with each of the nodes. This provides a cost function for each required edit operation. An edit script S between T₁ and T₂ is a sequence of edit operations turning T₁ into T₂. The cost of S is the sum of the costs of the operations in S. An optimal edit script between T₁ and T₂ is an edit script between T₁ and T₂ of minimum cost and this cost is the tree edit distance.

Optionally, step 204 may be repeated (not shown), for comparing the difference between one of the treatment plans (being the executed treatment plan) and a further, recommended treatment plan. By this repetition, it may be possible to determine which recommended treatment plan, of a plurality of provided recommended treatment plans, is the most similar to the executed treatment plan. The ability to accurately measure adherence to clinical practice enables clinical treatment improvements based on measurable results. For example, adherence measurement, when performing on large data sets coming from different hospitals, may allow more accurate performance assessment and comparison. More so, comparing adherence level scores over large data sets with hospital's clinical results may reveal best practices and procedures that correlate with poorer or better clinical outcomes.

In a step 206, an output is provided (e.g. displayed) to a user of method 200, based on the computed tree edit distance. The output may be the tree edit distance itself. Additionally or alternatively, the output may be a textual label indicating how great the tree edit distance is—e.g. “Treatment plans are identical”, “Treatment plans are slightly different”, “Treatment plans are moderately different”, or “Treatment plans are highly different”. Further additionally or alternatively, the output may be a numerical label indicating how similar the treatment plans are—e.g. “100%” (identical), “50%” (somewhat different), “0%” (completely different), etc. Generally, the output may be indicative of the compliance of the executed treatment plan with the recommended treatment plan, whether by denoting the amount of difference between the plans or the amount similarity.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
computing a tree edit distance between two medical treatment plans; and
displaying an output based on the computed tree edit distance.

2. The method according to claim 1, wherein:
the two medical treatment plans are a recommended treatment plan and an executed treatment plan; and
the output is indicative of compliance of the executed treatment plan with the recommended treatment plan.

3. The method according to claim 2, further comprising using said at least one hardware processor for repeating said computing for multiple recommended treatment plans,
wherein, in each repetition, a tree edit distance between the executed treatment plan and a different one of the multiple recommended treatment plans is computed, and
wherein the output indicates which of the multiple recommended treatment plans is closest to the executed treatment plan.

4. The method according to claim 1, wherein each of the two treatment plans is modeled as a tree structure having a hierarchy of nodes, wherein each of the nodes is labeled with a medical treatment descriptor.

5. The method according to claim 4, wherein:
each of said nodes is assigned with an edit cost indicative of a clinical significance of the edit, and
said computing of the tree edit distance is based on the edit cost.

6. The method according to claim 5, wherein the edit cost is defined by a human medical expert.

7. The method according to claim 5, wherein the edit cost is defined by a machine learning algorithm.

8. The method according to claim 7, wherein an input to the machine learning algorithm is historical treatment success data.

9. The method according to claim 7, wherein an input to the machine learning algorithm is a difference between the two medical treatment plans, as indicated by a human medical expert.

10. The method according to claim 5, wherein the edit cost is higher for nodes higher in the hierarchy and is lower for nodes lower in the hierarchy.

11. The method according to claim 5, wherein the edit cost is different for different types of edit operations.

12. A computer program product for medical treatment plan assessment, the computer program product comprising a non-transitory computer-readable storage medium having program code embodied therewith, the program code executable by at least one hardware processor for:
computing a tree edit distance between two medical treatment plans; and
displaying an output based on the computed tree edit distance.

13. The computer program product according to claim 12, wherein:
the two medical treatment plans are a recommended treatment plan and an executed treatment plan; and
the output is indicative of compliance of the executed treatment plan with the recommended treatment plan.

14. The computer program product according to claim 13, wherein the program code is further executable by said at least one hardware processor for repeating said computing for multiple recommended treatment plans,
wherein, in each repetition, a tree edit distance between the executed treatment plan and a different one of the multiple recommended treatment plans is computed, and
wherein the output indicates which of the multiple recommended treatment plans is closest to the executed treatment plan.

15. The computer program product according to claim 12, wherein each of the two treatment plans is modeled as a tree structure having a hierarchy of nodes, wherein each of the nodes is labeled with a medical treatment descriptor.

16. The computer program product according to claim 15, wherein:
each of said nodes is assigned with an edit cost indicative of a clinical significance of the edit, and
said computing of the tree edit distance is based on the edit cost.

17. The computer program product according to claim 16, wherein the edit cost is defined by a human medical expert.

18. The computer program product according to claim 16, wherein the edit cost is defined by a machine learning algorithm.

19. The computer program product according to claim 18, wherein an input to the machine learning algorithm is selected from the group consisting of: (a) historical treatment success data; and (b) a difference between the two medical treatment plans, as indicated by a human medical expert.

20. The computer program product according to claim 16, wherein the edit cost is higher for nodes higher in the hierarchy and is lower for nodes lower in the hierarchy.
